(19) United States
(12) Patent Application Publication
(10) Pub. No.: US 2015/0137602 A1
(43) Pub. Date: May 21, 2015

(54) POWER MANAGEMENT UNIT AND ITS APPLICATION IN APPARATUS AND METHOD FOR WIRELESS POWER SUPPLYING UNIT

(71) Applicant: RICHTEK TECHNOLOGY CORP, Hsinchu County (TW)

(72) Inventors: Wei-Jen Huang, Hsinchu County (TW); Tsung-Wei Huang, Hsinchu County (TW); Shui-Mu Lin, Hsinchu County (TW)

(73) Assignee: RICHTEK TECHNOLOGY CORP, Hsinchu County (TW)

(21) Appl. No.: 14/139,454

(22) Filed: Dec. 23, 2013

(30) Foreign Application Priority Data
Nov. 18, 2013 (TW) 102141878

(51) Int. Cl. H02J 4/00

(52) U.S. Cl. CPC H02J 4/00
USPC 307/52

(57) ABSTRACT

A power management unit, adapted to a wireless power supplying unit, for switching between input powers and providing a rated voltage or a variable flow current is provided. The power management unit includes a rectifying unit, a regulating unit, and a control unit. The rectifying unit converts AC power into DC power. The regulating unit is connected to the rectifying unit and generates a stable rated voltage or a variable flow current. The control unit is connected to the regulating unit and controls the input power driving the regulating unit. In addition, an apparatus and a method for a wireless power supplying unit are provided.

### CROSS-REFERENCE TO RELATED APPLICATIONS

This non-provisional application claims priority under 35 U.S.C. §119(a) on Patent Application No. 102141878 filed in Taiwan, R.O.C. on Nov. 18, 2013, the entire contents of which are hereby incorporated by reference herein.

### BACKGROUND OF THE INVENTION

1. Field of the Invention

The present invention relates to a power signal processing platform and, more particularly, to a wireless power management.

2. Description of Related Art

Wireless charging (also known as “inductive charging” or “non-contact inductive charging”) uses a near-field magnetic induction, or inductive coupling, to transfer energy from a power supplying device (or a charger) to an electrical device, which can then use that energy to charge batteries or run the device. Because energy is sent from the charger to the electrical device in use through an inductive coupling, wire connection is not required between the charger and the electrical device in use and thus no any conductive joints are exposed on these devices.

With design of no conductive joints, electrical devices that use wireless charging are free from the risk of electric shock. Being enclosed and protected in the power supplying device, a power transmitting component is away from water or oxygen in the atmosphere, thus avoiding corrosion. Besides, electrical devices having free of conductive joints do not have the problems of mechanic wear-and-tear and electric flashover that may cause due to constantly plugging and unplugging in conventional electrical devices.

Wireless charging finds its benefit in providing safer medical implants. For embedded medical devices, wireless charging allows recharging/powering through human skin rather than having wires penetrate the skin and any human tissue, which would adversely increase the risk of infection.

It is worth noting that convenience is the most advantage that wireless charging provides. Rather than having to connect a power cable, the electrical device being charged can be placed close to the charger. From technical point of view, the charger can be configured to charge multiple electrical devices at the same time, an advantage which requires less chargers and power sockets, thereby avoiding the mess caused by twined power cables.

A conventional mechanism for wireless charging (or power supplying) includes two charging paths, one for charging through wireless power and the other through wired power. In the charging path through wireless power, AC power is first converted into DC power through an electronic circuit by which the received wireless power is rectified and regulated, and then the DC power is transformed, through a charging unit (either a linear or a switching charger) external to the electronic circuit, into a rated voltage associated with a load for its operations. In the charging path through wired power, the wired power is directly connected to a charging unit so that the wired power is transformed into a rated voltage associated with a load for its operations.

In the charging path through wireless power, a linear charger (or a switching charger) can be alternatively incorporated into the electronic circuit such that the electronic circuit can directly charge a battery. In such mechanism, the functionality of the electronic circuit is more complete, and hardware cost is reduced by removing the charging unit. However, a separated charging unit is still required in the charging path through wired power.

The two wireless charging mechanisms mentioned above require an extra charging unit, which adversely increases the area of the printed circuit board (PCB), where the electronic circuit is resided, and thus the costs. Therefore, there exists some room to improve in terms of costs.

### BRIEF SUMMARY OF THE INVENTION

In view of the aforementioned problems, the present invention provides a power management unit and its application in an apparatus and a method for a wireless power supplying unit in order to lower design costs. Specifically, the separated charging unit is incorporated to make the functionality of the power management unit more complete and reduce design costs.

A power management unit as in an embodiment of the present invention is disclosed. The power management unit, which is adapted to an apparatus for a wireless power supplying unit, switches between input powers and provides a rated voltage. The power management unit of the present invention includes a rectifying unit, a regulating unit, and a control unit. The rectifying unit converts AC power into DC power. The regulating unit is connected to the rectifying unit and provides a stable rated voltage or a variable flow current. The control unit is connected to the regulating unit and controls the input power of the regulating unit.

An apparatus for a wireless power supplying unit as in another embodiment of the present invention is disclosed. The apparatus for a wireless power supplying unit of the present invention includes a secondary coil, a switching unit, and a power management unit. The secondary coil receives an AC electromagnetic field and generates AC power. The switching unit is configured to switch between input powers where the input powers include a wired power and a wireless power. The power management unit controls the switching unit to switch between input powers and provides a stable rated voltage or a variable flow current. The power management unit further includes following units: a rectifying unit connected to the secondary coil for converting AC power into DC power; a regulating unit connected to both the rectifying unit and the switching unit for transforming the received DC power into a stable rated voltage or a variable flow current; and a control unit, which is connected to the rectifying unit, the switching unit, and the regulating unit and controls the input power of the regulating unit.

The advantageous effect of the present invention with reference to the prior art is that the charging unit is incorporated into the power management unit so that a load is directly powered. Moreover, the power management unit provides a mechanism of switching between two power paths (i.e., the wired power and the wireless power), each of which is directed to the power management unit, and once one of the power paths is determined, the load is directly provided with the selected power. Through such mechanism, no extra charging unit is required and thereby the cost is reduced.

The present invention can be alternatively configured to charge a battery directly. Since battery types vary with different electronic products, the present invention is not limited to charging of one single load at a time; instead, multiple loads can be charged at the same time. It is worth noting that the present invention is applied not only to a battery to be charged but to a load that needs to be powered.

### BRIEF DESCRIPTION OF THE SEVERAL VIEWS OF DRAWINGS

The advantages of the present invention will be best understood by referring to the following detailed description of some illustrative embodiments in conjunction with the accompanying drawings, in which:

FIG. 1 is a schematic drawing of a power management unit and its application in an apparatus for a wireless power supplying unit according to the first and second embodiments of the present invention;

FIG. 2 is a method for a wireless power supplying unit according to the third embodiment of the present invention; and

FIG. 3 is a method for a wireless power supplying unit according to the fourth embodiment of the present invention.

### DETAILED DESCRIPTION OF THE INVENTION

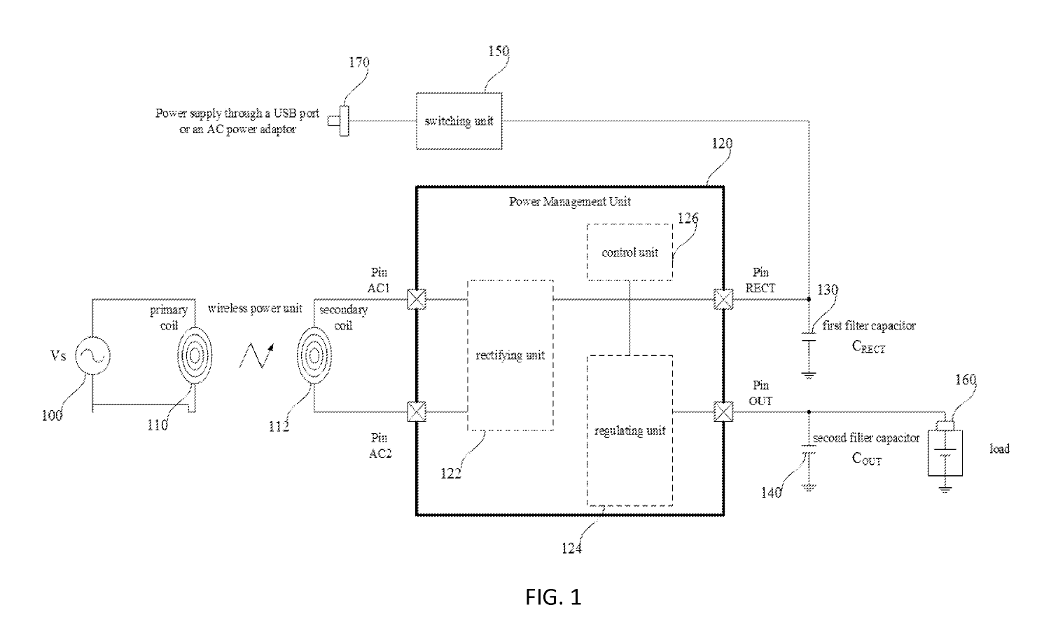

A power management unit is shown in FIG. 1 for the first embodiment of the present invention. The power management unit 120 includes a rectifying unit 122, a regulating unit 124, and a control unit 126.

The power management unit 120 as in FIG. 1 can be implemented by any type of electronic circuit or a chipset implemented by a semiconductor process. In the embodiment, the power management unit 120 is exemplified by a chipset implemented by a semiconductor process.

As shown in FIG. 1, a rectifying unit 122 is included in the power management unit 120 and is in communication with the external chip of the power management unit 120 via two chip pins: AC1 and AC2. An external AC power is transmitted into the rectifying unit 122 of the power management unit 120 via the two chip pins, and, after receiving the power, the rectifying unit 122 converts the power into a DC power as an input power. The AC power is generated by an external secondary coil 112 after receiving an AC electromagnetic field. Here the input power from the rectifying unit 122 is denoted as a wireless power.

The rectifying unit 122 is connected to the regulating unit 124, which is then driven by the DC power converted by the rectifying unit 122. The input port of the regulating unit 124 is connected to both the output port of the rectifying unit 122 and the control unit 126 and is in communication with the external chip of the power management unit 120 via a chip pin, RECT, as shown in FIG. 1.

The power driving the regulating unit 124 comes from two paths. One is from the aforementioned wireless power (i.e., the DC power converted by the rectifying unit based on the AC power transformed by the secondary coil), and the other is from an external DC power transmitted via the chip pin RECT, where the external DC power may be provided through, but not limited to, a universal serial bus (USB) port or an AC adaptor. Here the input power from outside of the power management unit is denoted as a wired power.

The control unit 126 is configured to determine that, during operation, the input power driving the regulating unit 124 is either from the DC power output by the rectifying unit 122 or from the wired power transmitted via the chip pin RECT.

The control unit 126 may use, but not limited to, following approaches to determine the input power. First, the control unit 126 is programmed by an instruction so as to determine the input power driving the regulating unit 124. Second, referring to FIG. 1, the control unit 126 automatically detects if a voltage exists at a connection port for wired power 170. If a voltage is detected, it is sure that the connection port for wired power 170 is connected to an external power, and then the control unit 126 determines that the power driving the regulating unit 124 is from the wired power. If no voltage is detected, the control unit 126 detects the voltage difference between the chip pin AC1 and the chip pin AC2, both of which separately connect to the secondary coil 112. If there exists a voltage difference, it is sure that an AC power is transformed by the secondary coil 112 after receiving an AC electromagnetic field, and then the control unit 126 determines that the power driving the regulating unit 124 is from the wireless power.

After being driven by the input power (DC), the regulating unit 124 transforms the power into a stable rate voltage and transmits the voltage out of the power management unit via a chip pin, OUT, through which the power management unit communicates with the outside of the chip. The rated voltage may be set to a specific value by requirement, for example, a value of 5V±0.5V. Alternatively, the regulating unit 124 transforms the DC power into a variable flow current and transmits the current out of the power management unit via the chip pin OUT.

Either the rated voltage or the variable flow current output from the power management unit 120 is directly provided to a load. For example, the power management unit charges a load, where the load can be a lithium-ion battery.

The application of the power management unit in a wireless power supplying unit is illustrated in the second embodiment of the present invention. Referring to FIG. 1, the wireless power supplying unit includes a power supplying device 100, a primary coil 110, a secondary coil 112, a power management unit 120, a first filter capacitor 130, a second filter capacitor 140, a switching unit 150, a load 160, and a connection port for wired power 170. The power management unit 120 further includes a rectifying unit 122, a regulating unit 124, and a control unit 126.

The power supplying device 100, as shown in FIG. 1, provides an AC power and can be, but not limited to, a regular socket or an off-the-shell AC power supply.

The AC power provided by the power supplying device 100 is received by a primary coil 110 by which an AC electromagnetic field is generated. The primary coil is made of a single metallic wire, and the metallic wire can be of any material, thickness, and number of turns. For example, the primary coil can be a copper wire with 2400 turns.

The AC electromagnetic field generated by the primary coil 110 is received by a secondary coil 112 by which an AC power is generated. The secondary coil is made of a single metallic wire, and the metallic wire can be of any material, thickness, and number of turns. For example, the secondary coil can be a copper wire with 240 turns.

The AC power generated by the secondary coil is directly transmitted to the rectifying unit 122 of the power management unit 120 via the chip pins AC1 and AC2, as shown in FIG. 1. After receiving the AC power, the rectifying unit 122 converts the AC power into a DC power.

The rectifying unit 122 is connected to the regulating unit 124, which is driven by the converted DC power transmitted from the rectifying unit 122. Here the input power (i.e., the converted DC power) driving the regulating unit 124 is denoted as a wireless power. The input port of the regulating unit 124 is connected to both the rectifying unit 122 and the control unit 126 and is in communication with the outside of the chip of the power management unit 120 via a chip pin, RECT, as shown in FIG. 1.

The powers driving the regulating unit 124 come from two paths. One is from the aforementioned wireless power (i.e., the DC power converted by the rectifying unit based on the AC power transformed by the secondary coil), and the other is from an external DC power transmitted via the chip pin RECT, where the external DC power may be provided through, but not limited to, a universal serial bus (USB) port or an AC adaptor. Here the input power from outside of the power management unit 120 is denoted as a wired power.

The control unit 126 is configured to determine that, during operation, the input power driving the regulating unit 124 is either from the DC power output by the rectifying unit 122 or from the wired power transmitted via the chip pin RECT. Besides, the control unit 126 is in communication with the switching unit 150 via the chip pin RECT and controls the switching unit 150 to switch between the wired power and the wireless power.

The control unit 126 may use, but not limited to, following approaches to determine the input power. First, the control unit 126 is programmed by an instruction so as to determine the input power driving the regulating unit 124. Second, referring to FIG. 1, the control unit 126 automatically detects if a voltage exists at a connection port for wired power 170. If a voltage is detected, it is sure that the connection port for wired power 170 is connected to an external power, and then the control unit 126 determines that the power driving the regulating unit 124 is from the wired power. If no voltage is detected, the control unit 126 detects the voltage difference between the chip pin AC1 and the chip pin AC2, both of which separately connect to the secondary coil 112. If there exists a voltage difference, it is sure that an AC power is transformed by the secondary coil 112 after receiving an AC electromagnetic field, and then the control unit 126 determines that the power driving the regulating unit 124 is from the wireless power.

After being driven by the input power (DC), the regulating unit 124 transforms the power into a stable rate voltage and transmits the voltage out of the power management unit 120 via a chip pin, OUT, through which the power management unit 120 communicates with the outside of the chip. The rated voltage may be set to a specific value by requirement, for example, a value of 5V±0.5V. Alternatively, the regulating unit 124 transforms the DC power into a variable flow current and transmits the current out of the power management unit 120 via the chip pin OUT.

The load 160 is connected to the regulating unit 124 of the power management unit 120 via the chip pin OUT. The voltage or the current output generated by the regulating unit 124 directly provides required power to the load 160 for its operations. For example, the regulating unit 124 directly charges the load 160, where the load 160 can be, but not limited to, a lithium-ion battery.

The first filter capacitor 130, which is external to the power management unit 120, is connected to rectifying unit 122 of the power management unit 120 via the chip pin RECT in order to stabilize and smoothen the rated voltage generated by the rectifying unit 122 so as to improve the efficiency of the regulating unit 124. For the first filter capacitor, in general, large capacitor stabilizes the output and thus makes the output voltage smoother; small capacitor, on the other hand, removes the high-frequency interference and thus makes the output voltage cleaner. Therefore, the selection of capacitor is determined by requirement.

The second filter capacitor 140, which is external to the power management unit 120, is connected to the regulating unit 124 of the power management unit 120 via the chip pin OUT in order to stabilize and smoothen the rated voltage generated by the regulating unit 124 so as to improve the efficiency of the regulating unit 124 in respect to the load 160. For the second filter capacitor, in general, large capacitor stabilizes the output and thus makes the output voltage smoother; small capacitor, on the other hand, removes the high-frequency interference and thus makes the output voltage cleaner. Therefore, the selection of capacitor is determined by requirement.

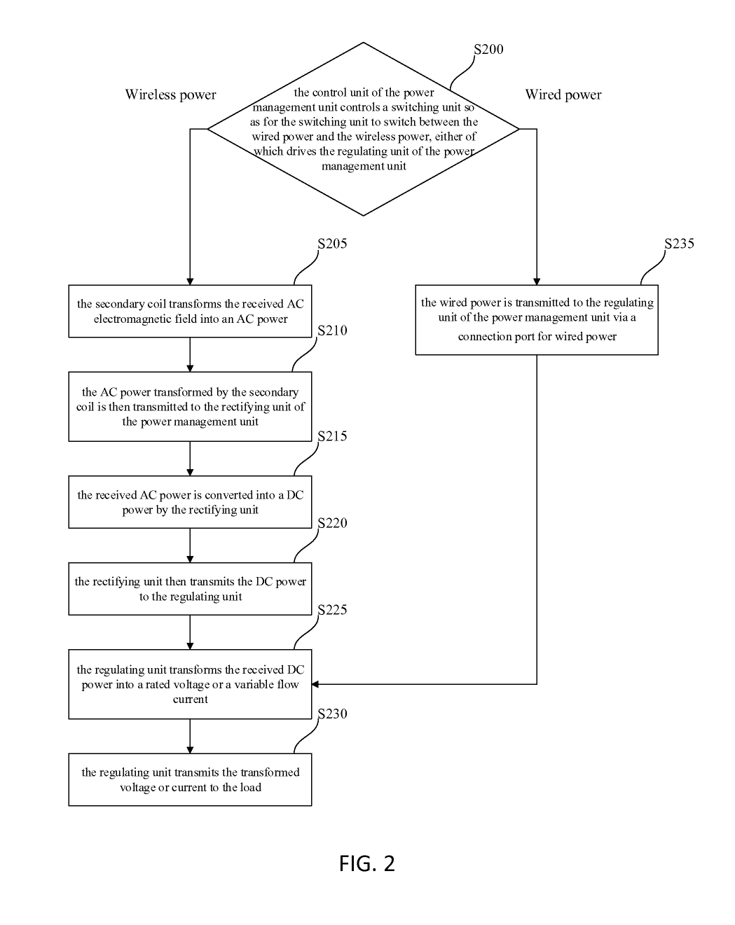

Please refer to FIG. 2, with reference to FIG. 1, for a method for a wireless power supplying unit in accordance with the third embodiment of the present invention.

The method for a wireless power supplying unit includes steps from step 200 to step 235, as shown in FIG. 2. The method begins with the step 200 where the control unit 126 of the power management unit controls a switching unit so as for the switching unit to switch between the wired power and the wireless power, either of which drives the regulating unit 124 of the power management unit. The power management unit 120 includes a control unit 126 and a rectifying unit 122. The control unit 126 is connected to the rectifying unit 122 and the switching unit 150. If the control unit 126 determines that the input power driving the regulating unit 124 is from the wired power, the control unit 126 controls the switching unit 150 to switch to the wired power, and, on the other hand, if the control unit 126 determines that the input power driving the regulating unit 124 is from the wireless power, the control unit 126 controls the switching unit 150 to switch to the wireless power.

The control unit 126 may use, but not limited to, following approaches to determine the input power. First, the control unit 126 is programmed by an instruction so as to determine the input power driving the regulating unit 124. Second, referring to FIG. 1, the control unit 126 automatically detects if a voltage exists at a connection port for wired power 170. If a voltage is detected, it is sure that the connection port for wired power 170 is connected to an external power, and then the control unit 126 determines that the power driving the regulating unit 124 is from the wired power. If no voltage is detected, the control unit 126 detects the voltage difference between the chip pin AC1 and the chip pin AC2, both of which separately connect to the secondary coil 112. If there exists a voltage difference, it is sure that an AC power is transformed by the secondary coil 112 after receiving an AC electromagnetic field, and then the control unit 126 determines that the power driving the regulating unit 124 is from the wireless power.

In step 200, if the control unit 126 controls the switching unit 150 to switch to the wireless power, then the secondary coil transforms the received AC electromagnetic field into an AC power (step 205). Please refer to FIG. 1, a power supplying device 100 is connected to a primary coil 110 and provides an AC power to the primary coil 110 by which an AC electromagnetic field is generated. After receiving the AC electromagnetic field, the secondary coil 112 transforms the AC electromagnetic field into an AC power. The power supplying device as in the embodiment can be, but not limited to, a regular power supply or simply a power socket.

The AC power transformed by the secondary coil is then transmitted to the rectifying unit 122 of the power management unit (step 210). Since the secondary coil 112 is connected to the rectifying unit 122 of the power management unit 100, the AC power transformed from the AC electromagnetic field by the secondary coil 112 is directly transmitted to the rectifying unit 122 of the power management unit 100.

Next, the received AC power is converted into a DC power by the rectifying unit 122 (step 215). The rectifying unit 122 then transmits the DC power to the regulating unit 124 (step 220). Since the rectifying unit 122 is connected to the regulating unit 124, the rectifying unit 122 transmits the DC power to drive the regulating unit 124 immediately after the AC power is converted into a DC power.

In step 225, the regulating unit 124 transforms the received DC power into a rated voltage or a variable flow current. The regulating unit 124 keeps the output voltage from being affected by the input power or the load 160 so as to maintain a stable output. According to the requirements by users or the load 160, the regulating unit 124 either outputs a rated voltage, for example, a rated voltage of 5 V, or outputs a variable flow current, for example, a current of 100 mA for 15 min from the beginning, followed by a current between 20 mA to 100 mA for 15 min.

Next, the regulating unit 124 transmits the transformed voltage or current to the load 160 (step 230). The regulating unit 124 is connected to the load 160, where the load 160 can be a regular lithium-ion battery.

In step 200, if the control unit 126 controls the switching unit 150 to switch to the wired power, the wired power is transmitted to the regulating unit 124 of the power management unit 100 via a connection port for wired power 170 (step 235). Referring to FIG. 1, an external power is connected to a connection port for wired power 170, and the DC power is transmitted to the regulating unit 124 of the power management unit 100 via the connection port for wired power 170. The external power can be, but not limited to, a DC power server through a universal serial bus (USB) port, or a power socket connected to an AC/DC adapter.

The regulating unit 124 then transforms the received DC power into a rated voltage or a variable flow current, as depicted in the step 225. The regulating unit 124 keeps the output voltage from being affected by the input power or the load 160 so as to maintain a stable output. According to the requirements by users or the load 160, the regulating unit 124 either outputs a rated voltage, for example, a rated voltage of 5 V, or outputs a variable flow current, for example, a current of 100 mA for 15 min from the beginning, followed by a current between 20 mA to 100 mA for 15 min.

Next, the regulating unit 124 transmits the transformed voltage or current to the load 160 (step 230). Since the regulating unit 124 is connected to the load 160, the regulating unit 124 can directly provide voltage or current to the load 160. For example, the regulating unit 124 directly charges the load 160, where the load 160 can be a regular lithium-ion battery.

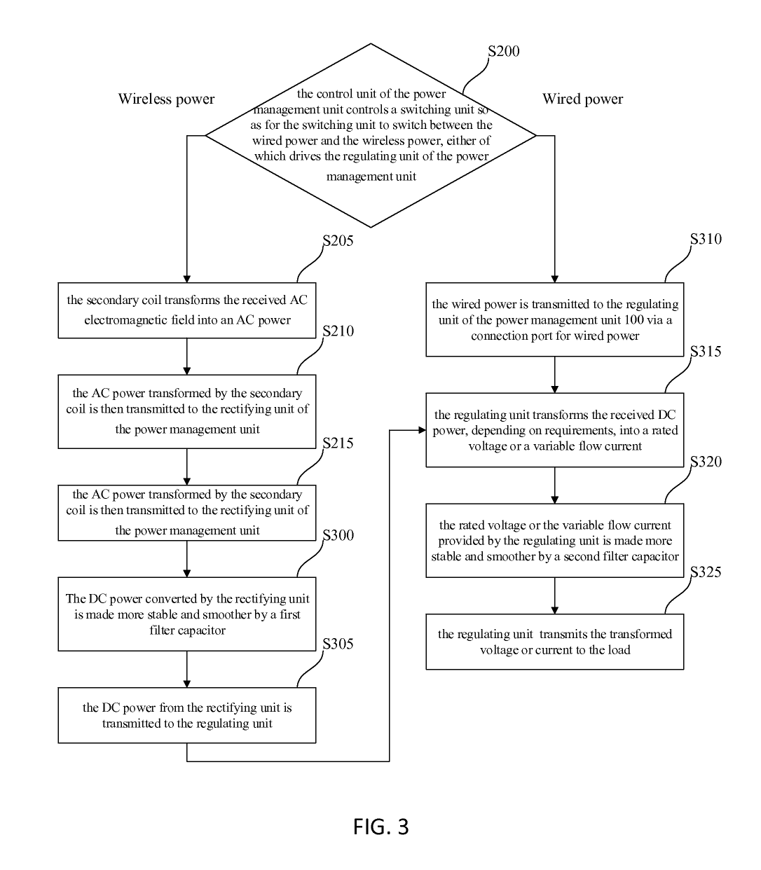

Please refer to FIG. 3, with reference to FIG. 1, for a method for a wireless power supplying unit in accordance with the fourth embodiment of the present invention.

As shown in FIG. 3, the steps 200 to 215 are the same as the steps in FIG. 2, but the difference comes after step 215. The DC power converted by the rectifying unit 122 is made more stable and smoother by a first filter capacitor (step 300). Meanwhile, the DC power from the rectifying unit 122 is transmitted to the regulating unit 124 (step 305). Since the rectifying unit 122 is connected to the regulating unit 124, the rectifying unit 122 transmits the DC power to the regulating unit 124 immediately after the AC power is converted into the DC power so as to drive the regulating unit. The first filter capacitor 130 is connected to the rectifying unit 122 and the regulating unit 124 such that the DC power provided by the rectifying unit 122 is made more stable and smoother. For the first filter capacitor 130, in general, large capacitor stabilizes the output and thus makes the output voltage smoother; small capacitor, on the other hand, removes the high-frequency interference and thus makes the output voltage cleaner. Therefore, the selection of capacitor is determined by requirement.

In step 315, the regulating unit 124 transforms the received DC power, depending on requirements, into a rated voltage or a variable flow current. The regulating unit 124 keeps the output voltage from being affected by the input power or the load 160 so as to maintain a stable output. According to the requirements by users or the load 160, the regulating unit 124 either outputs a rated voltage, for example, a rated voltage of 5 V, or outputs a variable flow current, for example, a current of 100 mA for 15 min from the beginning, followed by a current between 20 mA to 100 mA for 15 min.

Next, the rated voltage or the variable flow current provided by the regulating unit 124 is made more stable and smoother by a second filter capacitor 140 (step 320). The second filter capacitor 140 is connected to the regulating unit 124 such that the rated voltage or the variable flow current provided by the regulating unit 124 can be made more stable and smoother. For the second filter capacitor 140, in general, large capacitor stabilizes the output and thus makes the output voltage smoother; small capacitor, on the other hand, removes the high-frequency interference and thus makes the output voltage cleaner. Therefore, the selection of capacitor is determined by requirement.

In step 325, the regulating unit 124 transmits the transformed voltage or current to the load 160. The regulating unit 124 is connected to the load 160 so as to directly provide the voltage or the current to the load 160, where the load 160 can be a regular lithium-ion battery.

In step 200, if the control unit 126 controls the switching unit 150 to switch to the wired power, the wired power is transmitted to the regulating unit 124 of the power management unit 100 via a connection port for wired power 170 (step 310). Referring to FIG. 1, an external power is connected to a connection port for wired power 170, and the DC power is transmitted to the regulating unit 124 of the power management unit 100 via the connection port for wired power 170. The external power can be, but not limited to, a DC power server through a universal serial bus (USB) port or a power socket connected to an AC/DC adapter.

The regulating unit 124 transforms the received DC power into a rated voltage or a variable flow current, as depicted in the step 315. The regulating unit 124 keeps the output voltage from being affected by the input power or the load 160 so as to maintain a stable output. According to the requirements by users or the load 160, the regulating unit 124 either outputs a rated voltage, for example, a rated voltage of 5 V, or outputs a variable flow current, for example, a current of 100 mA for 15 min from the beginning, followed by a current between 20 mA to 100 mA for 15 min.

Next, the rated voltage or the variable flow current provided by the regulating unit 124 is made more stable and smoother by a second filter capacitor 140 (step 320). The second filter capacitor 140 is connected to the regulating unit 124 such that the rated voltage or the variable flow current provided by the regulating unit 124 can be made more stable and smoother. For the second filter capacitor 140, in general, large capacitor stabilizes the output and thus makes the output voltage smoother; small capacitor, on the other hand, removes the high-frequency interference and thus makes the output voltage cleaner. Therefore, the selection of capacitor is determined by requirement.

The regulating unit 124 transmits the transformed voltage or current to the load 160 (step 325). The regulating unit 124 is connected to the load 160 so as to directly provide the voltage or the current to the load 160. For example, the regulating unit 124 directly charges the load 160, where the load 160 can be a regular lithium-ion battery.

In summary, according to the embodiments, especially in respect to FIG. 1, the power management unit of the present invention is capable to switch between input powers (i.e., the wired power and the wireless power), either of which is driven to the regulating unit of the power management unit so as to provide a rated voltage or a variable flow current. After determining the input power, the power management unit controls the switching unit to switch to the input power. The input power is then transformed and provided to the load. Through such mechanism, external charging units as in prior art are not required, thereby lowering design costs. It is worth noting that the present invention is applied not only to a battery to be charged but to a load that needs to be powered.

What is claimed is:

1. A power management unit, adapted to an apparatus for a wireless power supplying unit, for switching between input powers and providing a stable rated voltage or a variable flow current, said power management unit comprising:
a rectifying unit for converting an AC power into an DC power;
a regulating unit connected to said rectifying unit and driven by an input power, for generating a stable rated voltage or a variable flow current; and
a control unit connected to said regulating unit, for controlling the input power driving said regulating unit.

2. The power management unit of claim 1, wherein said power management unit is a chipset implemented by a semiconductor process.

3. The power management unit of claim 1, wherein the magnitude of the stable rated voltage or the variable flow current is adjustable by requirement.

4. The power management unit of claim 1, wherein the input power is from either a wired power or a wireless power.

5. An apparatus for a wireless power supplying unit, comprising:
a secondary coil for receiving an AC electromagnetic field and generating an AC power;
a switching unit for switching between input powers, wherein the input power is from either a wired power or a wireless power; and
a power management unit controlling said switching unit to switch between input powers and providing a stable rated voltage or a variable flow current, said power management unit further comprising:
a rectifying unit connected to said secondary coil, for converting an AC power into a DC power;
a regulating unit connected to said rectifying unit and said switching unit, for transforming the received input power into a stable rated voltage or a variable flow current; and
a control unit, connected to said rectifying unit, said switching unit, and said regulating unit, for controlling the input power driving said regulating unit.

6. The apparatus for a wireless power supplying unit of claim 5, wherein said power management unit is a chipset implemented by a semiconductor process.

7. The apparatus for a wireless power supplying unit of claim 5, wherein the magnitude of the stable rated voltage or the variable flow current is adjustable by requirement.

8. The apparatus for a wireless power supplying unit of claim 5, further comprising a first filter capacitor connected to said rectifying unit and said regulating unit.

9. The apparatus for a wireless power supplying unit of claim 5, further comprising a second filter capacitor connected to said regulating unit.

10. The apparatus for a wireless power supplying unit of claim 5, further comprising a connection port for a wired power, wherein said connection port for a wired power is connected to said switching unit and is optionally connected to an external power for transmitting the wired power.

11. The apparatus for a wireless power supplying unit of claim 5, wherein said secondary coil is a coil of predetermined geometric shape.

12. The apparatus for a wireless power supplying unit of claim 5, further comprising a load connected to said regulating unit, wherein said regulating unit directly provides power to said load.

13. A method for a wireless power supplying unit, comprising:
providing a secondary coil for receiving an AC electromagnetic field and generating an AC power;
providing a power management unit for converting the AC power generated by said secondary coil into a DC power and providing a stable rated voltage or a variable flow current, said power management unit further comprising:
converting said AC power generated by said secondary coil into a DC power by a rectifying unit and driving a regulating unit by said DC power;
generating a stable rated voltage or a variable flow current by said regulating unit; and
determining that an input power driving said regulating unit is from a wired power or a wireless power by a control unit; and
providing a switching unit so as for said power management unit to control to switch between the wired power and the wireless power.

14. The method of claim 13, wherein said control unit of said power management unit controls to switch between the wired power and the wireless power by said switching unit.

15. The method of claim 13, further comprising said regulating unit of said power management unit generating a stable rated voltage or a variable flow current and directly providing the stable rated voltage or the variable flow current to a load.

16. The method of claim 13, further comprising making the DC power that is converted by said rectifying unit more stable and smoother by a first filter capacitor.

17. The method of claim 13, further comprising making the stable rated voltage that is provided by said regulating unit more stable and smoother by a second filter capacitor.

18. The method of claim 13, further comprising providing a connection port for a wired power which is able to connect to an external power for providing said regulating unit with the wired power.

19. The method of claim 18, wherein the wireless power driving said regulating unit is provided by the external AC electromagnetic field and the wired power driving said regulating unit is provided by the external power.

20. The method of claim 13, wherein the wireless power driving said regulating unit is provided by the external AC electromagnetic field and the wired power driving said regulating unit is provided by the external power.
